(19) United States
(12) Patent Application Publication
(10) Pub. No.: US 2017/0149690 A1
(43) Pub. Date: May 25, 2017

(54) Resource Aware Classification System

(71) Applicant: Dell Products L.P., Round Rock, TX (US)

(72) Inventors: Olivier Le Rudulier, Halifax (CA); Jeffrey C. Pick, Hammonds Plains (CA)

(21) Appl. No.: 14/948,133

(22) Filed: Nov. 20, 2015

(51) Int. Cl. H04L 12/911; H04L 12/26; H04L 12/863

(52) U.S. Cl. CPC H04L 47/821; H04L 47/50; H04L 43/0888

(57) ABSTRACT

A data classification component of an enterprise system that integrates computing resource information and network traffic information in near real time to control the impact of transmitting and classifying unstructured data on an overall enterprise system. In some cases, the classification component may combine the computing asset and network performance information for each local resource with computing assets and network performance information associated with a central classification service/server to organize and prioritize classification activities within the overall system to improve and maintain throughput associated with normal system operation

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As the overall amount of unstructured data continues to increase, so does the recourse cost associated with classifying, searching, and maintaining the unstructured data in an organized manner. Traditionally, computer systems rely upon a specialized central system to classify the unstructured data by analyzing the unstructured data and generating text based indexing for each file. However, transmitting the data files to and from the central system consumes large amounts of bandwidth and often requires access to specialized high speed communication network systems.

### SUMMARY

In one implementation, a data classification system that integrates computing resource information and network traffic information in near real time to control the impact of transmitting and classifying unstructured data on an overall enterprise system. For instance, a central classification or scheduler component may leverage native modules installed on local resources of a data repository, such as local file shares or local file servers. In this instance, the native modules may in part monitor and collect information related to available computing assets (e.g., central processing unit (CPU) usage, random access memory (RAM) usage, input/output (I/O) utilization, etc.) and network performance characteristics (e.g., upload and download bandwidth, throughput, latency, etc.) for the local host resource. Thus, the computing asset and network performance information may be provided to the central classification or scheduler component in near real time. The central classification or scheduler component may combine the computing asset and network performance information for each local resource with computing assets and network performance information associated with a central classification service/server to organize and prioritize classification activities within the overall system to improve and maintain overall system throughput.

In some implementations, the system is capable of aggregating over a predefined or customizable period of time. For example, the central classification or scheduler component or other component of the system may aggregate computing asset and network performance information over one hour periods and analyze the aggregated data to determine patterns over time. In some cases, the pattern information may be utilized by the central classification or scheduler component to reduce the number of task context switches to further reduce the overall amount of computing and network assets and resources consumed by classification activities.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an example system including a central classification component to coordinate classification activities.

FIG. 2 illustrates an example system including a central classification component to coordinate classification activities based on historical load statics.

FIG. 3 illustrates another example system including a central classification component to coordinate classification activities based on historical load statics.

FIG. 4 is an example flow diagram showing an illustrative process to generate classification tasks.

FIG. 5 is an example flow diagram showing an illustrative process to adjust the resource pool in near real time.

FIG. 6 is an example flow diagram showing an illustrative process to adjust the resource pool based on historical load statics.

FIG. 7 illustrates an example classifier that may be utilized by the classification component to assist with classifying the unstructured data.

FIG. 8 illustrates an example configuration of a computing device that can be used to implement the systems and techniques described herein.

### DETAILED DESCRIPTION

This disclosure includes techniques and implementations to organize and/or classify unstructured data (such as image data, video data, voice or audio data, etc.) stored in one or more data repositories. For instance, data classification systems, described herein, may be configured to receive and process computing resource information and network traffic information in near real time to control the impact of transmitting and classifying unstructured data on an overall enterprise system level. For instance, a central classification or scheduler component may leverage native modules installed on local resources, local file shares or local file servers, of one or more of the data repositories. In this instance, the native modules may in part monitor and collect information related to available computing assets (e.g., central processing unit (CPU) usage, random access memory (RAM) usage, input/output (I/O) utilization, etc.) and network performance characteristics (e.g., upload and download bandwidth, throughput, latency, etc.) for the local host resource.

In this manner, the computing asset and network performance information may be provided to the central classification or scheduler component in near real time. The central classification or scheduler component may analyze and process the computing asset and network performance information for each local resource as well as the computing assets and network performance information associated with a central classification service/server or other resources assigned to the classification system to organize and prioritize classification activities within the overall system to improve and maintain overall system throughput. Thus, the amount of network and computing resources consumed by the classification task at any particular time may be reduced or maintained at a level that allows normal enterprise activates to be performed without a degradation in system performance.

In some cases, the classification system may be configured to increase classification activities during time periods in which resource usage is lower (e.g., reduced) compared to other time periods. For example, resource usage may be lower overnight, on weekends, on holidays, etc. However, enterprise systems that provide world wide support may result in fewer and/or shorter periods of reduced usage. Therefore, in some implementations, the classification system is capable of aggregating network and resource information over a predefined (or customizable) period of time. For example, the central classification or scheduler component or other component of the system may aggregate computing asset and network performance information over time periods (e.g., one hour periods) and analyze the aggregated data to determine patterns over time, which may be stored as historical load statistics. In some cases, the historical load statistics may be analyzed by the central classification or scheduler component (e.g., using a machine learning algorithm) to identify periods of time during which the enterprise system experiences reduced usage. The central classification or scheduler component may also utilize the historical load statistics to identify inefficiencies caused by unnecessary changes in classification activities, such as task context switches.

In some cases, the central classification or scheduler component may rank or prioritize classification activates into different levels, such that higher priority data is classified first. For instance, the classification system may include priority rankings for data, such as high, medium, and low. In one example, data unstructured corporate data may include work related data, office management data, and social data. In this example, the work related data may be categorized as high priority, because the corporation uses the work related data to carry out revenue earning tasks (e.g., a part schematic). The office management data may be categorized as mid-level priority, because the office management data is used by the corporation but may not be time sensitive (e.g., a new office assignment map). The social data may be categorized as low-level priority, as the social data may be unrelated or only peripherally related to work (e.g., sharing office photos).

In some cases, the central classification or scheduler component may make near real time determinations to adjust the amount of classification activities being performed by the enterprise system. For example, the central classification or scheduler component may be governed by a set of resource consumption policy rules that set various thresholds for increasing throughput of the enterprise system. For example, the central classification or scheduler component may include a threshold (e.g., a maximum) percentage of resources that may be utilized by the classification system (e.g., 20% of host throughput with 3% allowable margin of error), a maximum average CPU usages (e.g., 15% of host total CPU capabilities over 20 seconds), a maximum peak percentage of CPU usage over a predefined period of time (e.g., 75% of host total CPU capabilities over a period of less than 20 seconds), a maximum average I/O usage (e.g., 10% of host I/O capabilities), a maximum peak percentage of I/O usage over time (e.g., 30% of host total I/O capabilities over 60 seconds), a maximum average RAM usage (e.g., 20% of host I/O capabilities), a maximum peak percentage of RAM usage over time (e.g., 40% of host total RAM capabilities over 30 seconds), among others.

In other examples, the central classification or scheduler component may make resource allocation decisions based at least in part on computing growth policy. For example, the central classification or scheduler component may determine that each of the permanent computing units or resources are being utilized at (or within a predetermined threshold of) full capacity for a predefined period of time (such as one hour). The central classification or scheduler component may also determine that the high priority task queue is above a first threshold, the medium priority task queue is above a second threshold, and/or the low priority task queue is above a third threshold. In response, the central classification or scheduler component may request additional computing resources be allocated or allowed to be utilized by the classification system to accommodate the growth in the overall amount of unstructured data or activities associated with the data's classification.

For purposes of this disclosure, a classification system may include any computer or network resources or aggregate resources operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes to organize and/or classify unstructured data. For example, an classification system may include one or more data repositories, such as personal computers (e.g., desktop or laptop), server devices (e.g., blade server or rack server), enterprise computing resources or devices, cloud based storage, tablet computer, mobile device (e.g., personal digital assistant (PDA) or smart phone), a network storage device, or any other suitable device and may vary in size, shape, performance, functionality, and price. The classification system may include any number of random access memories (RAM), one or more processing resources such as a central processing unit (CPU) or hardware or software control logic, ROM, and/or other types of nonvolatile memory. Additional components of the classification system may include one or more disk drives, one or more network ports for communicating with external devices as well as various input and output (I/O) devices, such as a keyboard, a mouse, touchscreen and/or a video display. The classification system may also include one or more buses operable to transmit communications between the various hardware components.

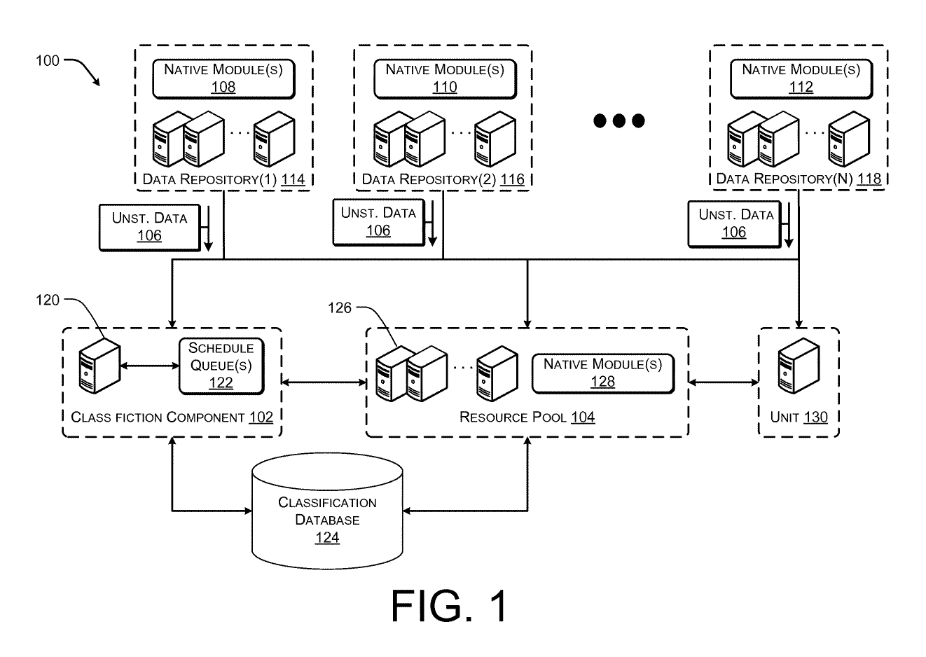

FIG. 1 illustrates an example system 100 including a central classification component 102 to coordinate classification activities. For example, the central classification component 102 may identify, priority, and assign classification tasks to computing resources available in the virtualized classification resource pool 104. However, unlike traditional classification systems that utilize large amounts of network bandwidth transmitting the unstructured data 106 over various devices of the system 100, the central classification component 102 utilizes native modules 108, 110, and 112 associated with corresponding data repositories (1)-(N), illustrated as data repositories 114, 116, and 118, to capture computing resource information and network traffic information associated with the data repositories 114-118 in near real time. The central classification component 102 utilizes native modules 128 associated with corresponding resources, generally indicated by 126, of the virtualized resource pool 104 to capture computing resource information and network traffic information associated with other resources associated with the system 100 in near real time. The central classification component 102 may then analyze the computing resource information and network traffic information to schedule, prioritize, and assign tasks to the various local resources available in the virtualized resource pool 104.

The central classification component 102 may include various computing resources, generally illustrated as sever 120. For example, the computing resources may include a CPU-type processing unit, a GPU-type processing unit, a Field-programmable Gate Array (FPGA), another class of digital signal processor (DSP), or other hardware logic components that can, in some instances, be driven by a CPU. For example, and without limitation, illustrative types of hardware logic components that can be used include Application-Specific Integrated Circuits (ASICs), Application-Specific Standard Products (ASSPs), System-on-a-chip Systems (SOCs), Complex Programmable Logic Devices (CPLDs), etc. The classification component 102 also includes one or more schedule queues 122 including a list of tasks generated by the classification component 102 in response to identifying or receiving unstructured data 106 within or from the data repositories 114-118. In one example, the schedule queues 122 may include multiple queue of classification tasks, each of the queues associated with tasks having different priorities. For instance, the schedule component 102 may include a high priority queue, a medium priority queue, and a low priority queue. In some cases, the classification component 102 may be incorporated into one or more of the data repositories 114-118 or other computing device associated with the system 100.

The resource pool 104 represents the computing resources and storage components available to the system 100 for performing tasks and activities. In some cases, the resource pool 104 may be fixed. In other cases, the resource pool 104 may be a virtualized elastic pool. For example, the resource pool 104 may include one or more cloud based resources that may be added or removed from the pool 104 depending on the overall resource usage of the system 100. In some instances, the resources within the pool 104 may include resources associated with the data repositories 114-118 as described below.

In some implementations, the data repositories 114-116 may include various types of storage components, such as volatile and nonvolatile memory, removable and non-removable media implemented in any method or technology for storage of information, such as computer-readable instructions, data structures, program modules, or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store structured and unstructured data 106 and which can be accessed by various computing devices of the system 100.

The data repositories 114-116 may also include various computing resources such as, for example, a CPU-type processing unit, a GPU-type processing unit, a Field-programmable Gate Array (FPGA), another class of digital signal processor (DSP), or other hardware logic components that can, in some instances, be driven by a CPU. For example, and without limitation, illustrative types of hardware logic components that can be used include Application-Specific Integrated Circuits (ASICs), Application-Specific Standard Products (ASSPs), System-on-a-chip Systems (SOCs), Complex Programmable Logic Devices (CPLDs), etc.

Together, at least a portion of the storage components and the computing resources associated with the data repositories 114-116 may contribute to the resources available for task assignment by the classification component 102 and illustrated as the virtualized resource pool 104. Further, other systems or devices, generally indicated by 130 may also be assigned to the virtualized resource pool 104. These other systems or devices 126 may also include various storage components and computing resources. In some cases, additional devices may be added to the resource pool 104, such as unit 130.

In some implementations, the classification database 124 may include various types of storage components, such as volatile and nonvolatile memory, removable and non-removable media implemented in any method or technology for storage of information, such as computer-readable instructions, data structures, program modules, or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store data useful to assist in classification of the unstructured data 106.

The schedule component 102 and/or the storage components and the computing resources associated with the virtualized resource pool 104 may also utilize information or data stored in a classification database 124 in order to schedule classification tasks and/or to perform the classification tasks. For example, the classification database 124 may store rules, trees, examples, corpus data, comparison data, etc. that may be utilized by the storage components and the computing resources associated with the virtualized resource pool 104 to classify a particular files containing unstructured data 106.

In one example, the central classification component 102 may receive from or become aware of files unstructured data 106 stored in the data repositories 114-118. The classification component 102 may identify or generate classification task associated with each file. In some cases, the central classification component 102 may access information stored on the classification database 124 to assist with generating classification tasks and assignments.

In some cases, the central classification component 102 may also prioritize or rank various classification tasks according to an importance level. The classification component 102 may in part assign a prioritization level to each task based at least in part on information stored on the classification database 124, information known about, determined from, or associated with the unstructured data 106, the resource information and network traffic information associated with the local resources, for example the computing resources associated with the data repositories 114-116, the computing resources associated with other devices 126 of the system 100, and/or resource information and network traffic information associated with the classification component 102. Once the classification tasks are identified and leveled, the classification tasks may be placed in one or more of the schedule queues 122 and may be assigned to various resources within the virtualized resource pool 104.

The central classification component 102 also receives computing resource information and network traffic information associated with the data repositories 114-118 from the native modules 108-112 operating on each of the data repositories 114-118 and/or computing resource information and network traffic information associated with the devices 126 from the native modules 128 operating on each of the devices 126. The classification component 102 may assign classification tasks associated with the unstructured data 106 to various resources in the pool 104 including the data repositories 114-118 and any other device associated with the system 100 based at least in part on the computing resource information and network traffic information received from the native modules 108-112.

By utilizing the computing resource information and network traffic information associated with the data repositories 114-118 from the native modules 108-112 and/or computing resource information and network traffic information associated with the devices 126 from the native modules 128, the classification component 102 may increase or decrease the number of classification tasks being performed at any given time. For instance, the classification component 102 may utilize a global resources consumption policy together with the computing resource information and network traffic information to maintain the overall amount of resource consumption associated with classification activates to a predefined percentage.

In some examples, the resource consumption policy rules may include thresholds to maintain throughput associated with non-classification tasks performed by the system 100. For example, the resource consumption policy implemented by the central schedule component 102 may include a threshold (e.g., maximum) percentage of resources that may be utilized by the classification system (e.g., 20% of host throughput with 3% allowable margin of error), a maximum average CPU usages (e.g., 15% of host total CPU capabilities over 20 seconds), a maximum peak percentage of CPU usage over a predefined period of time (e.g., 75% of host total CPU capabilities over a period of less than 20 seconds), a maximum average I/O usage (e.g., 10% of host I/O capabilities), a maximum peak percentage of I/O usage over time (e.g., 30% of host total I/O capabilities over 60 seconds), a maximum average RAM usage (e.g., 20% of host I/O capabilities), a maximum peak percentage of RAM usage over time (e.g., 40% of host total RAM capabilities over 30 seconds), among others. The percentages described are purely for illustration purposes and may vary depending on the implementation.

In other examples, the central classification component 102 may make resource allocation decisions based at least in part on a computing growth policy. For example, the central classification component 102 may determine that available resources in the virtualized resource pool 104 are insufficient for performing both normal enterprise activities and classification tasks. The central classification component 102 may add additional units or resources to the pool 104. For instance, the illustrated example, the unit 130 may be added to the virtualized resource pool 104 in response to the central classification component 102 determining that the one or more of the queues 122 are above one or more thresholds (e.g., one or more of the schedule queues 122 are over 50% full, 70% full, 90% full, or a combination thereof).

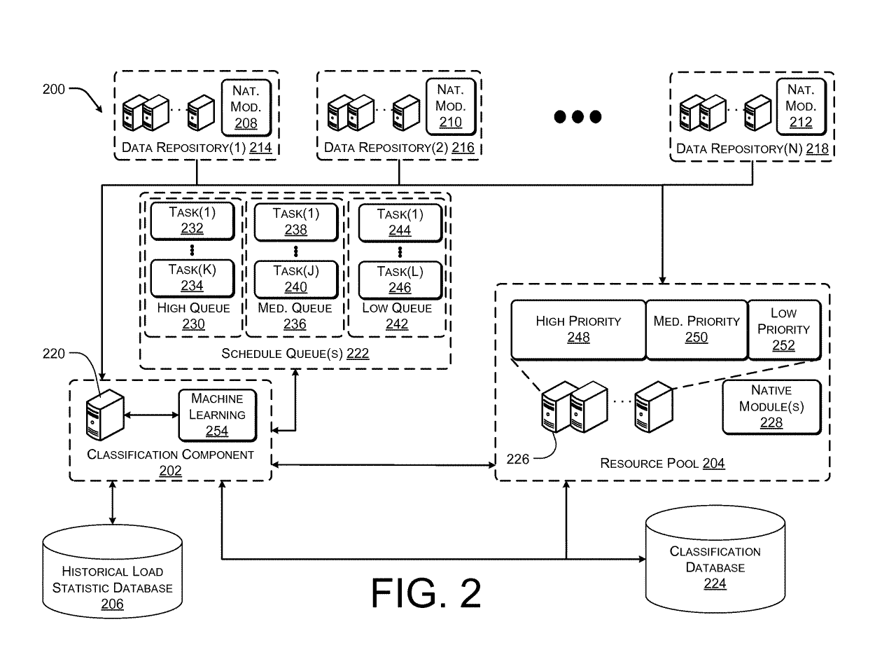

FIG. 2 illustrates an example system 200 including a central classification component 202 to coordinate classification activities based on historical load statics. For statistics, in some cases, the central classification component 202 may be configured to identify time periods in which there is reduced resource usage associated with the system 200 and to increase classification activities during these reduced resource usage time periods. For instance, the central classification component 202 may aggregate computing resource and network performance information associated with the virtualized resource pool 204 over defined periods of time and store the aggregated data in a historical load statistic database 206.

In the current example, the historical load statistic may be utilized by the central classification component 202 as an input (such as an input to a machine learning algorithm) to identify one or more periods of time during which the system 200 experiences reduce usages, to identify patterns associated with the time periods, and predict (e.g., based on the patterns) when periods of reduced resource usage may occur. The central classification component 202 may also utilize the historical load statistics to identify inefficiencies associated with unnecessary changes in classification activities, such as task context switches.

As described above, the central classification component 202 utilizes native modules 208, 210, and 212 associated with corresponding data repositories (1)-(N), illustrated as data repositories 214, 216, and 218, to capture computing resource information and network traffic information associated with the data repositories 214-218 in near real time. The central classification component 202 utilizes native modules 228 associated with corresponding resources, generally indicated by 226, of the virtualized resource pool 204 to capture computing resource information and network traffic information associated with other resources associated with the system 200 in near real time. The central classification component 202 may then analyze the computing resource information and network traffic information to schedule, prioritize, and assign tasks to the various local resources available in the virtualized resource pool 204.

The central classification component 202 may include various computing resources, generally illustrated as sever 220. The classification component 202 also includes one or more schedule queues 222 including a list of tasks generated by the classification component 202 in response to identifying or receiving unstructured data within or from the data repositories 214-218. In the illustrated example, the schedule queues 222 includes multiple queue of classification tasks, each of the queues associated with tasks having different priorities. For instance, the schedule queues 222 include a high priority queue 230 having high level tasks (1)-(K), generally indicated by 232 and 234, a medium priority queue 236 having medium level tasks (1)-(J), generally indicated by 238 and 240, and a low priority queue 242 having low level tasks (1)-(L), generally indicated by 244 and 246. In some cases, the classification component 202 may be incorporated into one or more of the data repositories 214-218 or other computing device associated with the system 200.

The resource pool 204 represents the computing resources and storage components available to the system 200 for performing tasks and activities. In some cases, the resource pool 204 may be fixed. In other cases, the resource pool 204 may be a virtualized elastic (e.g., on-demand) pool of resources. For example, the resource pool 204 may include one or more cloud based resources that may be added or removed from the pool 204 on-demand, e.g., depending on the overall resource usage of the system 200. In addition to the queues 230, 236, and 238, the resource pool 204 may partition the resource pool 204 into resource groups based on priority. For instance, in the illustrated example, the resource pool 204 includes a high priority group 248, a medium priority group 250, and a low priority group 252. In this example, the high priority group 248 is larger than both the medium priority group 250 and the low priority group 252 to represent that more of the resources within the pool 204 are assigned to perform tasks in the high priority queue 230 than resources within the pool 204 that are assigned to perform tasks in the medium priority queue 236 or the low priority queue 242. Likewise, the medium priority group 250 is larger than the low priority group 252. In some implementations, the resources assigned to any one of the groups 248-252 may vary depending on, for example, the number of tasks in any one of the queues 230, 236, or 242.

In some implementations, the data repositories 214-218 may include various types of storage components, such as volatile and nonvolatile memory, removable and non-removable media implemented in any method or technology for storage of information, such as computer-readable instructions, data structures, program modules, or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store structured and unstructured data and which can be accessed by various computing devices of the system 200.

The data repositories 214-218 may also include various computing resources such as, for example, a CPU-type processing unit, a GPU-type processing unit, a Field-programmable Gate Array (FPGA), another class of digital signal processor (DSP), or other hardware logic components that can, in some instances, be driven by a CPU. For example, and without limitation, illustrative types of hardware logic components that can be used include Application-Specific Integrated Circuits (ASICs), Application-Specific Standard Products (ASSPs), System-on-a-chip Systems (SOCs), Complex Programmable Logic Devices (CPLDs), etc.

The schedule component 202 and/or the storage components and the computing resources associated with the resource pool 204 may also utilize information or data stored in a classification database 224 in order to schedule classification tasks and/or to perform the classification tasks. For example, the classification database 224 may store rules, trees, examples, corpus data, comparison data, etc. that may be utilized by the storage components and the computing resources associated with the resource pool 204 to classify a particular files containing unstructured data.

In some implementations, the classification database 224 may include various types of storage components, such as volatile and nonvolatile memory, removable and non-removable media implemented in any method or technology for storage of information, such as computer-readable instructions, data structures, program modules, or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store data useful to assist in classification of the unstructured data.

Similarly, the classification database 206 may include various types of storage components, such as volatile and nonvolatile memory, removable and non-removable media implemented in any method or technology for storage of information, such as computer-readable instructions, data structures, program modules, or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store historical load statistical data related to the overall resource usage of the system 200 and/or the resource usage of the classification components.

In some examples, the classification component 202 may receive from or become aware of files unstructured data stored in the data repositories 214-218. The classification component 202 may identify or generate classification task, such as task 232, 234, 238, 240, 244, and 246, associated with each file. In some cases, the central classification component 202 may access information stored on the classification database 224 to assist with generating classification tasks and assignments.

In some cases, the central classification component 202 also receives computing resource information and network traffic information associated with the data repositories 214-218 from the native modules 208-212 operating on each of the data repositories 214-218 and/or computing resource information and network traffic information associated with the devices 226 from the native modules 228 operating on each of the devices 226. The classification component 202 may identify or generate classification task associated with the unstructured data based at least in part on the computing resource information and network traffic information received from the native modules 208-212 and 228.

In some implementations, the central classification component 202 may also prioritize or rank various classification tasks according to an importance level. For instance, in the illustrated example, the classification component 102 ranked the tasks 232 and 234 as high priority, the tasks 238 and 240 as medium priority, and tasks 244 and 246 as low priority. Once the classification tasks are identified and leveled, the classification tasks may be placed in one or more of the schedule queues 222 according to the assigned priority. For instance, in the illustrated example, the tasks 232 and 234 are queued in the high priority queue 230, the tasks 238 and 240 are queued in the medium priority queue 236, and tasks 244 and 246 are queued in the low priority queue 242.

In some examples, the classification component 202 may also adjust a percentage or amount of resources within the resource pool 204 that perform tasks associated with each of the particular queues 230, 236, and 242. For instance, the classification component 202 may assign 50% of the resources within the pool 204 to high priority tasks (the high priority group 248), 30% to medium priority tasks (the medium priority group 250), and 20% to low priority tasks (the low priority group 252). Thus, each of the queues 230, 236, and 242 continue to have tasks completed however, the higher the priority assigned by the classification component 202 the more likely that the task will be completed ahead of other tasks. In some situations, the classification component 202 may adjust the percentage or amount of resources assigned to any one of the queues 230, 236, and 242 for the benefit of another. For example, if the low priority queue has one hundred tasks and the medium priority queue had five tasks, the classification component 202 may decrease the percentage of the resources pool 204 assigned to the medium priority group 250 and increase the percentage of the resources pool 204 assigned to the low priority group 252 to balance the classification activities.

In one particular implementation, the classification component 202 may include or be coupled to a machine learning module or component 254. The machine learning module 254 may be configured to periodically receive data form the historical load statistic database 206 and to make adjustment to the overall amount of resources within the pool 204 and/or the time at which the resources are assigned/unassigned to classification activates. For example, based on the data form the historical load statistic database 206, the machine learning module 254 may identify a fifteen minute period on Wednesday that the enterprise operations of the system 200 typically fall below ten percentage resource utilization. By utilizing this information, the machine learning module 254 may cause the classification component 202 to increases the resources within the pool 204 during the fifteen minute window each Wednesday.

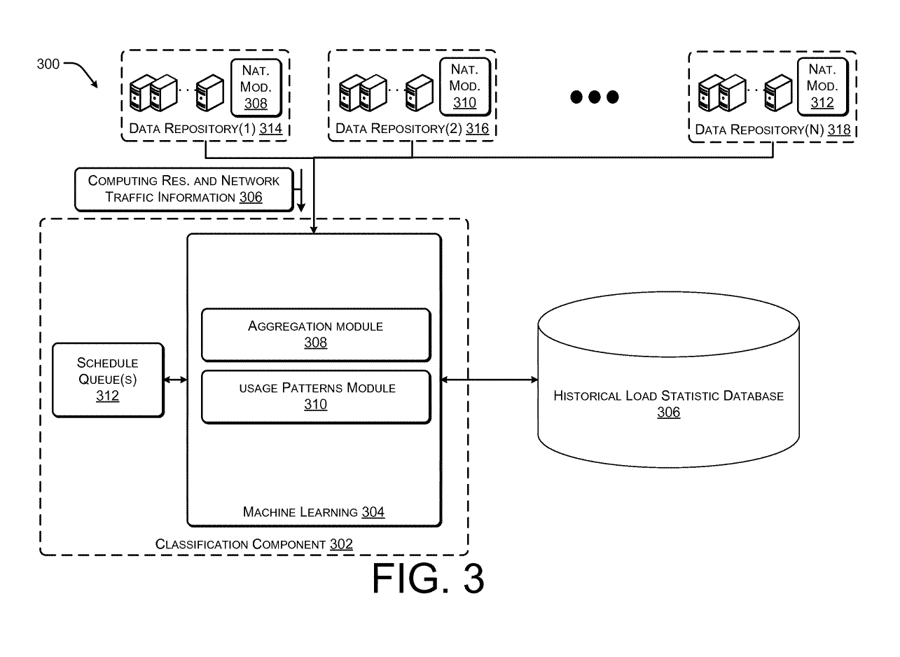

FIG. 3 illustrates another example system 300 including a central classification component 302 to coordinate classification activities based on historical load statics. For example, in some cases, the central classification component 302 may include a machine learning module or component 304 configured to identify reduced usage periods associated with the system 300 and/or individual resources within the systems 300 resource pool. The classification component 302 may then during these identified periods increase the classification activities.

For instance, the machine learning module 304 may receive computing resources and network traffic information 306 from one or more native module, such as modules 308, 310, and 312, operating on data repositories 314, 316, and 318 respectively. The machine learning module 304 may include an aggregation module 308 to aggregate information and store as historical load statics per data repository. For example, the machine learning module 304 may receive the computing resources and network traffic information 306 from each of the native modules 308, 310, and 312 and aggregate the computing resources and network traffic information 306 according to a period of time and the data repository corresponding go the appropriate native module 308, 310, and 312.

The machine learning module 304 may also include a usage pattern module 310 to analyze the historical load statics and to identify load usage patterns. For example, as discussed above, the machine learning module 304 may identify a fifteen minute period on Wednesday at which the system 300 usage is minimal. The machine learning module 304 may store any patterns or periods of time identified. Thus, the classification component 302 may utilize the patterns or periods of time identified to adjust the resources within the resource pool, adjust percentage of resources assigned to various priority schedule queues 312, or to adjust the position and/or number of tasks within the various priority schedule queues 312.

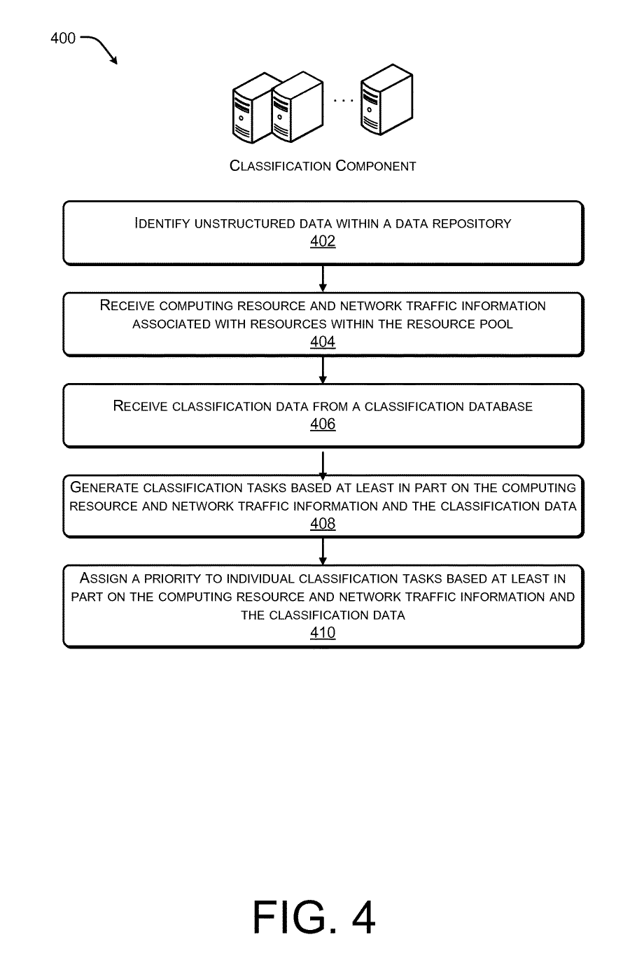

FIGS. 4-6 are flow diagrams illustrating example processes for implementing the classification system described herein. The processes are illustrated as a collection of blocks in a logical flow diagram, which represent a sequence of operations, some or all of which can be implemented in hardware, software or a combination thereof. In the context of software, the blocks represent computer-executable instructions stored on one or more computer-readable media that, which when executed by one or more processors, perform the recited operations. Generally, computer-executable instructions include routines, programs, objects, components, data structures and the like that perform particular functions or implement particular abstract data types.

The order in which the operations are described should not be construed as a limitation. Any number of the described blocks can be combined in any order and/or in parallel to implement the processes, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 4 is an example flow diagram showing an illustrative process 400 to generate classification tasks. In some examples, the classification systems may be configured to receive and process computing resource information and network traffic information in near real time to control the impact of transmitting and classifying unstructured data on an overall enterprise system level. For instance, a central classification or scheduler component may leverage native modules installed on local resources, local file shares or local file servers, of one or more of the data repositories. In this instance, the native modules may in part monitor and collect information related to available computing assets and network performance characteristics for the local host resource and provide the collected information to the classification component to assist with scheduling of the classification activates.

At 402, the classification component may identify unstructured data with a data repository of an enterprise system. For example, the data repository may signal or notify the classification component, the data repository may provide the unstructured data to the classification component, or the classification component may be notified by the native module monitoring the data repository.

At 404, the classification component may receive computing resource and network traffic information associated with resource within the resource pool. For instance, each device associated with the enterprise system may include a native module or agent configured to monitor the resource usage and/or the network traffic of the corresponding device. The native module on each device may then transmit the computing resource and network traffic information to the classification component in near real time.

At 406, the classification component may access or receive classification data form a classification database. For example, the classification database may store rules, trees, examples, corpus data, comparison data, etc. that may be utilized by the classification component to assist with generating classification tasks.

At 408, the classification component generates classification task based at least in part on the computing resource and network traffic information and the classification data. At 410, the classification component assigns a priority to individual classification tasks based at least in part on the computing resource and network traffic information and the classification data. For example, if a particular classification task may be given a higher priority when the computing resource usage and network traffic is high as fewer overall resources may be available to perform classification activities and a larger percentage of the classification resources may be assigned to the high priority queue.

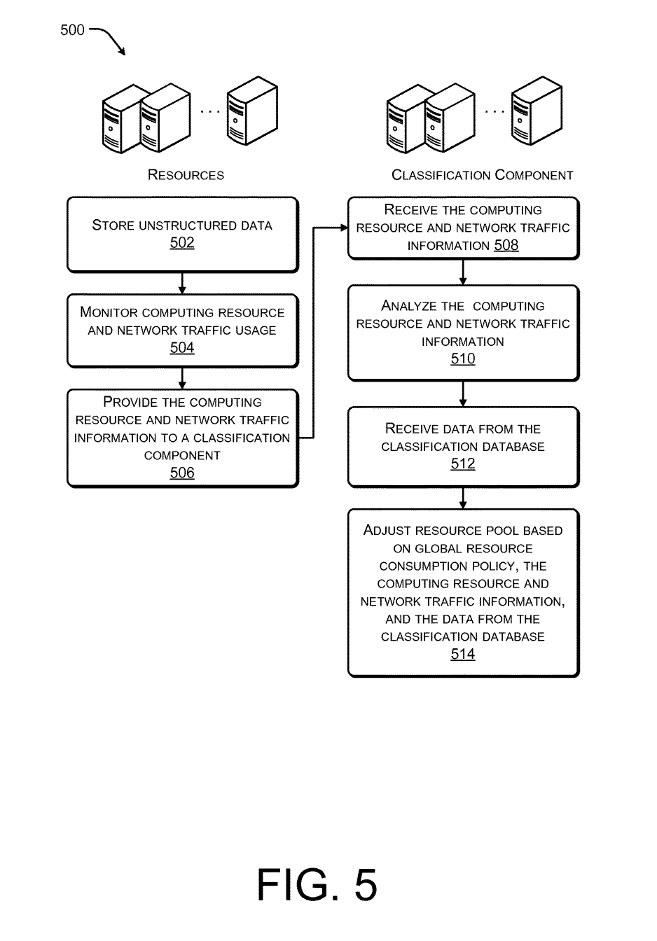

FIG. 5 is an example flow diagram showing an illustrative process to adjust the resource pool in near real time. As discussed above, the classification systems may be configured to receive and process computing resource information and network traffic information in near real time to control the impact of transmitting and classifying unstructured data on an overall enterprise system level. For instance, a central classification or scheduler component may leverage native modules installed on local resources, local file shares or local file servers, of one or more of the data repositories. In this instance, the native modules may in part monitor and collect information related to available computing assets and network performance characteristics for the local host resource and provide the collected information to the classification component to assist with scheduling of the classification activates.

At 502, one or more of the resources, such as the data repositories of FIGS. 1-3, may store a file containing unstructured data. The classification component may identify or be notified as to the unstructured data stored within the resource. For example, the resource may signal or notify the classification component, the resource may provide the unstructured data to the classification component, or the classification component may be notified by the native module monitoring the resource.

At 504, one or more native modules operating on each of the resources monitors the computing resources and the network traffic associated with the corresponding resource. For instance, each device associated with an enterprise system may include one or more modules or agents configured to monitor the resource usage and/or the network traffic of the corresponding device.

At 506, the modules or agent on each device may provide the computing resource and network traffic information to the classification component. For example, the modules or agent on each device may transmit the computing resource and network traffic information to the classification component in near real time or at predefined periods.

At 508, the classification component may receive computing resource and network traffic information associated with resource within the resource pool. For instance, as discussed above, each device associated with the enterprise system may include a native module or agent configured to monitor the resource usage and/or the network traffic of the corresponding device. The native module on each device may then transmit the computing resource and network traffic information to the classification component in near real time.

At 510, the classification component may analyze the computing resource and network traffic information. For example, the classification component may determine an overall resource and network availability, overall resource and network usage, a per resource or per device resource and network availability, etc. In some cases, the classification component may aggregate the computing resource and network traffic information, while in other cases the classification component may analyze the computing resource and network traffic information on a resource by resource basis.

At 512, the classification component may access or receive classification data form a classification database. For example, the classification database may store rules, trees, examples, corpus data, comparison data, etc. that may be utilized by the classification component to assist with generating classification tasks.

At 514, the classification component generates classification adjust the resource pool based on one or more global resource consumption policies or predefined thresholds/limits, the computing resource and network traffic information, and the data form the classification database. For example, the classification component may increase the resource pool if the computing resource usage and the network traffic are low, the resource pool is operating at ninety percent or high capacity, and the classification task queues are above a threshold.

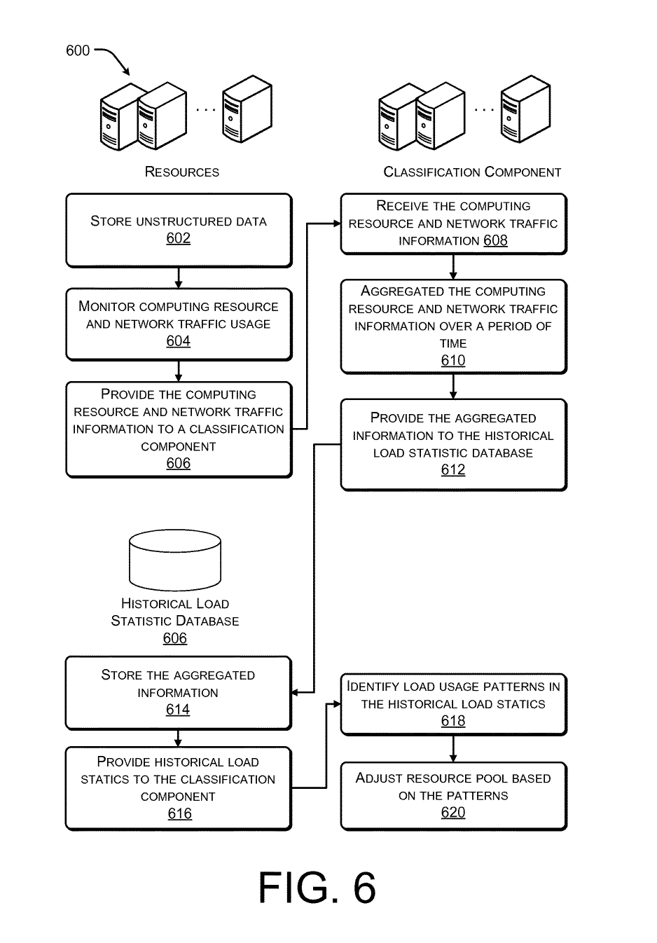

FIG. 6 is an example flow diagram showing an illustrative process to adjust the resource pool based on historical load statics. For instance, the classification system may be capable of aggregating network and resource information over a predefined or customizable period of time. For example, the central classification or scheduler component or other component of the system may aggregate computing asset and network performance information over one hour periods and analyze the aggregated data to determine patterns over time, which may be stored as historical load statistics. In some cases, the historical load statistics may be utilized by the central classification or scheduler component as an input (such as an input to a machine learning algorithm) to identify period of time at which the enterprise system regularly experiences reduce usages. The central classification or scheduler component may also utilize the historical load statistics to identify inefficient associated with unnecessary changes in classification activities, such as task context switches.

At 602, one or more of the resources, such as the data repositories of FIGS. 1-3, may store a file containing unstructured data. The classification component may identify or be notified as to the unstructured data stored within the resource. For example, the resource may signal or notify the classification component, the resource may provide the unstructured data to the classification component, or the classification component may be notified by the native module monitoring the resource.

At 604, one or more native modules operating on each of the resources monitors the computing resources and the network traffic associated with the corresponding resource. For instance, each device associated with an enterprise system may include one or more modules or agents configured to monitor the resource usage and/or the network traffic of the corresponding device.

At 606, the modules or agent on each device may provide the computing resource and network traffic information to the classification component. For example, the modules or agent on each device may transmit the computing resource and network traffic information to the classification component in near real time or at predefined periods.

At 608, the classification component may receive computing resource and network traffic information associated with resource within the resource pool. For instance, as discussed above, each device associated with the enterprise system may include a native module or agent configured to monitor the resource usage and/or the network traffic of the corresponding device. The native module on each device may then transmit the computing resource and network traffic information to the classification component in near real time.

At 610, the classification component may aggregate the computing resource and network traffic information over a period of time. For example, the classification component may determine an overall resource and network availability and/or an overall resource and network usage during the period of time. The classification component may also make determinations of the resource and network traffic usage of classification activates versus enterprise system activities.

At 612, the classification component may provide the aggregated information to one or more historical load statistic databases. At 614, the historical load statistic database stores the aggregated information. For example, the historical load statistic database may store the aggregated information in sets associated with the corresponding period of time.

At 616, the historical load statistic database may provide the aggregated information over multiple periods of time as historical load statics to the classification component. At 618, the classification component identifies patterns in the historical load statics. For example, the classification component may identify a fifteen minute period on Wednesday that the enterprise operations of the enterprise utilization falls below ten percentage resource utilization.

At 620, the classification component adjust the resource pool based at least in part on the patterns. For example, the classification component may increases the resources within the pool during the fifteen minute window each Wednesday to more efficiently utilize the overall resources of the system.

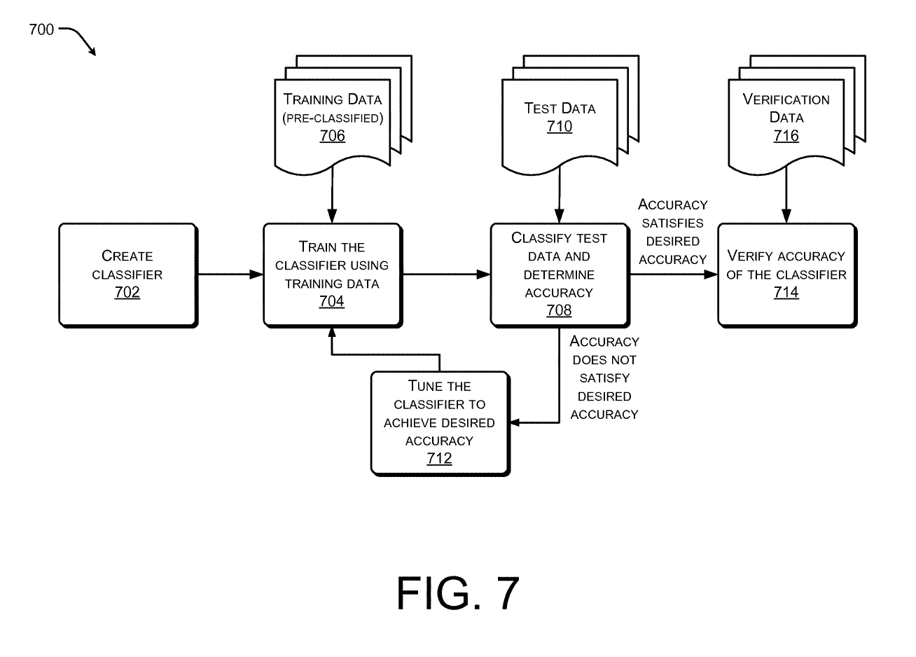

FIG. 7 illustrates an example classifier process 700 that may be utilized by the classification component to assist with classifying the unstructured data. At 702, the classifier algorithm is created. For example, software instructions that implement one or more algorithms may be written to create the classifier. The algorithms may implement machine learning, pattern recognition, and other types of algorithms, such as a support vector machine, decision trees, ensembles (e.g., random forest), linear regression, naive Bayesian, neural networks, logistic regression, perceptron, or other machine learning algorithm.

At 704, the classifier may be trained using training data 706. The training data 706 may include event logs, historical statistical usage data, computing resource and/or network traffic information, classification data, and data associated with classification tasks, etc.

At 708, the classifier may be instructed to classify test data 710. The test data 710 may have been pre-classified by a human, by another classifier, or a combination thereof An accuracy with which the classifier has classified the test data 710 may be determined. If the accuracy does not satisfy a desired accuracy, at 712 the classifier may be tuned to achieve a desired accuracy. The desired accuracy may be a predetermined threshold, such as ninety-percent, ninety-five percent, ninety-nine percent and the like. For example, if the classifier was eighty-percent accurate in classifying the test data and the desired accuracy is ninety-percent, then the classifier may be further tuned by modifying the algorithms based on the results of classifying the test data 710. Blocks 704 and 712 may be repeated (e.g., iteratively) until the accuracy of the classifier satisfies the desired accuracy.

When the accuracy of the classifier in classifying the test data 710 satisfies the desired accuracy, at 708, the process may proceed to 714 where the accuracy of the classifier may be verified using verification data 716. The verification data 716 may have been pre-classified by a human, by another classifier, or a combination thereof The verification process may be performed at 714 to determine whether the classifier exhibits any bias towards the training data 706 and/or the test data 710. The verification data 216 may be data that are different from both the test data 710 and the training data 706. After verifying, at 714, that the accuracy of the classifier satisfies the desired accuracy, the trained classifier 718 may be used to classify unstructured data files. If the accuracy of the classifier does not satisfy the desired accuracy, at 714, then the classifier may be trained using additional training data, at 704. For example, if the classifier exhibits a bias to the training data 706 and/or the test data 710, the classifier may be training using additional training data to reduce the bias.

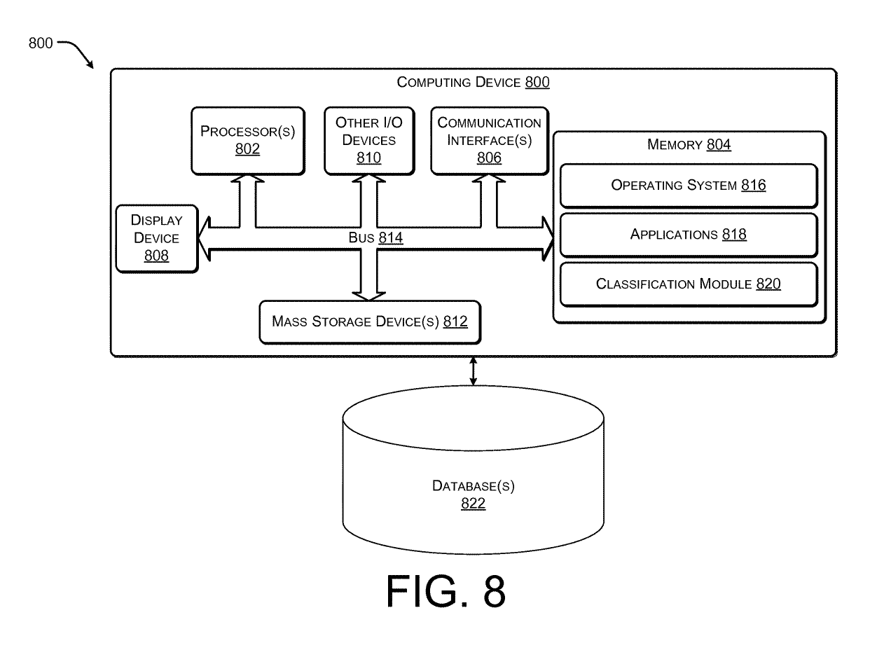

FIG. 8 illustrates an example configuration of a computing device 800 that can be used to implement the systems and techniques described herein. The computing device 800 may include one or more processors 802, a memory 804, communication interfaces 806, a display device 808, other input/output (I/O) devices 810, and one or more mass storage devices 812, configured to communicate with each other, such as via a system bus 814 or other suitable connection. In some implementations, the computing device 800 may be representative of the classification component discussed above.

The processor 802 is a hardware device (e.g., an integrated circuit) that may include a single processing unit or a number of processing units, all or some of which may include single or multiple computing units or multiple cores. The processor 702 can be implemented as one or more microprocessors, microcomputers, microcontrollers, digital signal processors, central processing units, state machines, logic circuitries, and/or any devices that manipulate signals based on operational instructions. Among other capabilities, the processor 802 can be configured to fetch and execute computer-readable instructions stored in the memory 804, mass storage devices 812, or other computer-readable media.

Memory 804 and mass storage devices 812 are examples of computer storage media (e.g., memory storage devices) for storing instructions which are executed by the processor 802 to perform the various functions described above. For example, memory 804 may generally include both volatile memory and non-volatile memory (e.g., RAM, ROM, or the like) devices. Further, mass storage devices 812 may include hard disk drives, solid-state drives, removable media, including external and removable drives, memory cards, flash memory, floppy disks, optical disks (e.g., CD, DVD), a storage array, a network attached storage, a storage area network, or the like. Both memory 804 and mass storage devices 812 may be collectively referred to as memory or computer storage media herein, and may be a media capable of storing computer-readable, processor-executable program instructions as computer program code that can be executed by the processor 802 as a particular machine configured for carrying out the operations and functions described in the implementations herein.

The computing device 800 may also include one or more communication interfaces 806 for exchanging data with other devices of the system via a network. The communication interfaces 806 can facilitate communications within a wide variety of networks and protocol types, including wired networks (e.g., Ethernet, DOCSIS, DSL, Fiber, USB etc.) and wireless networks (e.g., WLAN, GSM, CDMA, 802.11, Bluetooth, Wireless USB, cellular, satellite, etc.), the Internet and the like. Communication interfaces 806 can also provide communication with external storage (not shown), such as in a storage array, network attached storage, storage area network, or the like.

A display device 808, such as a monitor may be included in some implementations for displaying information and images to users. Other I/O devices 810 may be devices that receive various inputs from a user and provide various outputs to the user, and may include a keyboard, a remote controller, a mouse, a printer, audio input/output devices, and so forth.

The computer storage media, such as memory 804 and mass storage devices 812, may be used to store software and data. For example, the computer storage media may be used to store an operating system 816 and one or more other applications 818. The computer storage media may also store one or more modules associated with classification activities, generally illustrated as classification module 320. In some cases, the compunction interfaces 806 may allow the computing device 800 to receive data from one or more databases 822, such as the classification database or the historical load static database, to assist with classification activities, tasks, and scheduling.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Furthermore, this disclosure provides various example implementations, as described and as illustrated in the drawings. However, this disclosure is not limited to the implementations described and illustrated herein, and can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

Software modules include one or more of applications, bytecode, computer programs, executable files, computer-executable instructions, program modules, code expressed as source code in a high-level programming language such as C, C++, Perl, or other, a low-level programming code such as machine code, etc. An example software module is a basic input/output system (BIOS) file. A software module may include an application programming interface (API), a dynamic-link library (DLL) file, an executable (e.g., .exe) file, firmware, and so forth.

Processes described herein may be illustrated as a collection of blocks in a logical flow graph, which represent a sequence of operations that can be implemented in hardware, software, or a combination thereof. In the context of software, the blocks represent computer-executable instructions that are executable by one or more processors to perform the recited operations. The order in which the operations are described or depicted in the flow graph is not intended to be construed as a limitation. Also, one or more of the described blocks may be omitted without departing from the scope of the present disclosure.

Although the subject matter has been described in language specific to structural features, it is to be understood that the subject matter defined in the appended claims is not necessarily limited to the specific features described. Rather, the specific features are disclosed as illustrative forms of implementing the claims.

What is claimed is:

1. A system comprising:
a communication interface for commination;
one or more processors; and
one or more computer-readable storage media storing computer-executable instructions, which when executed by one or more processors, cause the one or more processors to:
receive a first set of computing resource data associated with a set of resources in the system, the first set of computing resource data received from a set of native modules, wherein individual native modules of the set of software native modules are associated with a resource of the set of resources, the first set of resource data including central processing unit usage;
in response to receiving the first set of computing resource data, adjust an amount of resources within a resource pool, the resource pool assigned to perform classification activities associated with unstructured data;
receive a second set of computing resource data associated with the set of resources, the second set of computing resource data received from the set of native modules; and
in response to receiving the second set of computing resource data, further adjust the amount of resources within the resource pool.

2. The system as recited in claim 1, wherein the computer-executable instructions, when executed by the one or more processors, further cause the one or more processors to:
identify the unstructured data within a data repository; and
generate one or more classification tasks to classify the unstructured data in response to identifying the unstructured data within the data repository.

3. The system as recited in claim 2, wherein the computer-executable instructions, when executed by the one or more processors, further cause the one or more processors to:
assign a priority to individual ones of the one or more classification tasks.

4. The system as recited in claim 2, wherein the computer-executable instructions, when executed by the one or more processors, further cause the one or more processors to:
receive classification information from a classification database; and
generate one or more classification tasks to classify unstructured data based at least in part on the classification information.

5. The system as recited in claim 2, wherein the computer-executable instructions, when executed by the one or more processors, further cause the one or more processors to:
assign individual ones of the one or more classification tasks to a schedule queue associated with classification tasks.

6. The system as recited in claim 1, wherein the computer-executable instructions, when executed by the one or more processors, further cause the one or more processors to:
receive a third set of computing resource data associated with the set of resources, the third set of computing resource data received from the set of native modules;
in response to receiving the third set of computing resource data, further adjust the amount of resources within the resource pool.

7. The system as recited in claim 1, wherein the computer-executable instructions, when executed by the one or more processors, further cause the one or more processors to:
aggregating, by the classification component, the first set of computing resource data and the second set of computing resource data; and
analyzing, by the classification component, the aggregated data to identify one or more patterns associated with resource usage; and
wherein adjusting the amount of resources within the resource pool is based at least in part on the one or more patterns.

8. A method comprising:
receiving, by a classification component from at least one native module operating on a plurality of devices associated with a system, computing resources usage associated with individual ones of the plurality of devices;
aggregating, by a classification component of the system, computing resource usage information associated with at least one of the plurality of devices, the computing resources information received by the classification component from individual ones of the local modules in near real time; and
adjusting, by the classification component, an amount of resources within a resource pool, the resources within the resource pool assigned to perform classification activities associated with unstructured data based at least in part on the aggregated computing resource usage information.

9. The method as recited in claim 8, further comprising:
storing the aggregated computing resource usage information based on periods of time as historical statistical data;
analyzing, by the classification component, the historical statistical data to identify one or more patterns associated with resource usage at a system level; and
wherein adjusting the amount of resources within the resource pool is based at least in part on the one or more patterns.

10. The method as recited in claim 8, further comprising:
identifying, by the classification component, the unstructured data within a data repository of the system;
generating one or more classification tasks to classify the unstructured data; and
assigning individual ones of the one or more classification tasks to a first priority queue based at least in part on the aggregated computing resource usage information.

11. The method as recited in claim 10, wherein adjusting the amount of resources within the resource pool includes adjusting a percentage of the resources within the resource pool assigned to the first priority queue.

12. A method comprising:
receive a first set of computing resource data associated with a set of resources in the system, the first set of computing resource data received from a set of native modules, wherein individual native modules of the set of software native modules are associated with a resource of the set of resources, the first set of resource data including central processing unit usage; and
in response to receiving the first set of computing resource data, adjust an amount of resources within a resource pool, the resource pool assigned to perform classification activities associated with unstructured data.

13. The method as recited in claim 12, further comprising:
receive a second set of computing resource data associated with the set of resources, the second set of computing resource data received from the set of native modules, the second set of computing resource data received at a period of time after receiving the first set of computing resource data; and
in response to receiving the second set of computing resource data, further adjust the amount of resources within the resource pool.

14. The method as recited in claim 13, further comprising:
receive a third set of computing resource data associated with the set of resources, the third set of computing resource data received from the set of native modules, the third set of computing resource data received at a period of time after receiving the first set of computing resource data and the second set of computing resource data;
in response to receiving the third set of computing resource data, further adjust the amount of resources within the resource pool.

15. The method as recited in claim 12, further comprising:
identify the unstructured data within a data repository; and
generate one or more classification tasks to classify the unstructured data in response to identifying the unstructured data within the data repository.

16. The method as recited in claim 12, further comprising:
receive classification information from a classification database; and
generate one or more classification tasks to classify unstructured data based at least in part on the classification information.

17. The method as recited in claim 16, further comprising:
assign individual ones of the one or more classification tasks to a schedule queue associated with classification tasks.

18. The method as recited in claim 12, wherein adjusting the amount of resources within the resource pool includes adjusting a percentage of the resources within the resource pool assigned to a first priority queue, the first priority queue inducing classification tasks to be completed by the resources.

19. The method as recited in claim 12, wherein adjusting the amount of resources within the resource pool includes adding additional hardware capabilities to the resource pool.

20. The method as recited in claim 12, wherein adjusting the amount of resources within the resource pool includes removing hardware capabilities from the resource pool.
